(19) United States
(12) Patent Application Publication
(10) Pub. No.: US 2011/0309643 A1
(43) Pub. Date: Dec. 22, 2011

(54) Door lock and jamb strike plates

(76) Inventor: Gerald F. Pope, Orange Park, FL (US)

(21) Appl. No.: 12/801,659

(22) Filed: Jun. 18, 2010

(51) Int. Cl. E05B 15/02; B26F 1/38

(52) U.S. Cl. 292/340; 83/13

(57) ABSTRACT

The door lock and jamb strike plates may be stamped or otherwise formed of metal plate of conventional thickness, but include screw passages and receptacles for the screw heads having axes defining oblique angles between the planes of the plates and the screw axes. In the case of the door lock or deadbolt mortise plates, the screw head receptacles and passages are angled away from one another, with their axes oriented away from the knob and latch mechanism therebetween. In the case of the jamb strike plate or jamb deadbolt plate, the screw head receptacles and passages are oriented to pass into the center of the wood structure behind the plate to provide additional strength. The plates may be provided individually or as a kit, with or without screws.

### BACKGROUND OF THE INVENTION

1. Field of the Invention

The present invention relates generally to door lock and latch mechanisms, and particularly to door lock and jamb strike plates configured for more secure installation than is the case with conventional plates.

2. Description of the Related Art

Lock mechanisms for doors and other openings have been known for a considerable period of time. In the past, such devices were often very easy to defeat by a person with some knowledge of these mechanisms. More recent developments in the lock field have resulted in lock mechanisms that are quite difficult to defeat, even by a very knowledgeable and skilled individual.

As a result, persons with criminal intent have found that it is often easier and much quicker to just use brute force to break a lock mechanism. Often the lock mechanism remains undamaged when force is applied, but the surrounding conventional wood structure in which the mechanism is installed will often break to allow the door to be swung open. This is because the conventional door latch mortise plate or jamb strike plate assembly is often secured to the door or jamb by relatively short screws that are fairly easy to break loose by kicking the door, and these screws are installed relatively close to one edge of the jamb in a conventional installation. Moreover, these screws will often loosen and perhaps back out over time, given frequent use of the door over a long period of time. The result is that it is often not particularly difficult to literally break into a home or other structure where the door is secured by conventional locks, bolts, and latch and strike plates.

As a result, a number of different lock and latch mechanisms and assemblies have been developed in the past with the intent of providing better security. Many of these devices are relatively complex and specialized components that require fairly extensive modification of the door and/or jamb structure for proper installation. Many of these components are relatively thick and heavy and require additional work to modify the door and/or jamb to allow the installation of such thicker, heavier components. Yet, many such components are secured to their structures by conventional, relatively short screws, resulting in the same problems as occur with conventional door lock and latch hardware. This appears to be due to the relatively thin or narrow framing materials used in the construction of hollow core doors, and in the construction of most homes and many other structures. Conventionally, the hardware attachment screws driven into the jamb penetrate only the jamb facing material, and perhaps the shims conventionally installed between the jamb facing and the door opening framing studs. It can be difficult, if not impossible, to provide sufficient material thickness to accommodate a conventionally driven screw in many such structures.

Thus, door lock and jamb strike plates solving the aforementioned problems are desired.

### SUMMARY OF THE INVENTION

The door lock and jamb strike plates may be stamped or otherwise formed of sheet metal material (brass, steel, etc.) of conventional thickness. Each of the plates includes a pair of screw attachment holes or passages having depressions for the heads of the screws so that the screw heads do not protrude above the exposed surface of the plate when completely driven. However, the screw passages and screw head depressions are oriented so that their axes form acute angles with the plane of the plate, rather than the screw axis being normal to the plane of the plate, as is provided conventionally. The plates are of conventional thickness, such that the screw head depressions protrude from the back surfaces of the plates.

In the case of the jamb strike plate or deadbolt plate, the axes of the screw passages and screw head depressions or receptacles are parallel to one another, but are aligned at an acute angle between their axes and the plane of the plate to extend away from the closure edge of the plate. When longer than conventional screws are used, this results in the screws being driven essentially through the center portions of the doubled framing studs forming the door frame, rather than being driven into the wood near one edge of the material where it is easier to break the material by means of force.

In the case of the door latch or deadbolt mortise plate, the axes of the screw passages and their screw head depressions or receptacles are oriented opposite one another, i.e., the two axes are angled away from the central bolt or latch mechanism therebetween. In a hollow core or paneled door this results in the screws being driven deeply into the horizontal lock rail material above and below the bore hole for the knob and latch assembly, with the screws passing through the vertical latch stile of the door to span the weakened area that has been cut out for the knob and latch assembly. This strengthens the door and latch assembly at this point, with this portion of a conventional door and latch or lock assembly otherwise being a weak point.

The various jamb and latch or deadbolt plates may be provided individually as required by the user, or may be provided as a kit to include all of the components needed for installation in a door jamb and door assembly. The door latch or door deadbolt mortise plates may be provided in combination with a knob and latch assembly, or may be provided as a separate component for installation in a shallow mortised receptacle around the latch or lock bolt.

These and other features of the present invention will become readily apparent upon further review of the following specification and drawings.

### BRIEF DESCRIPTION OF THE DRAWINGS

FIG. 1 is a perspective view of a door lock and jamb strike plates kit according to the present invention.

FIG. 2 is a perspective view of an alternative embodiment of a door lock and jamb strike plates kit according to the present invention for a deadbolt installation.

FIG. 3 is an environmental top plan view in section, showing the installation of the door latch and jamb strike plates of FIG. 1.

FIG. 4 is section view along lines 4-4 of FIG. 3.

Similar reference characters denote corresponding features consistently throughout the attached drawings.

### DETAILED DESCRIPTION OF THE PREFERRED EMBODIMENTS

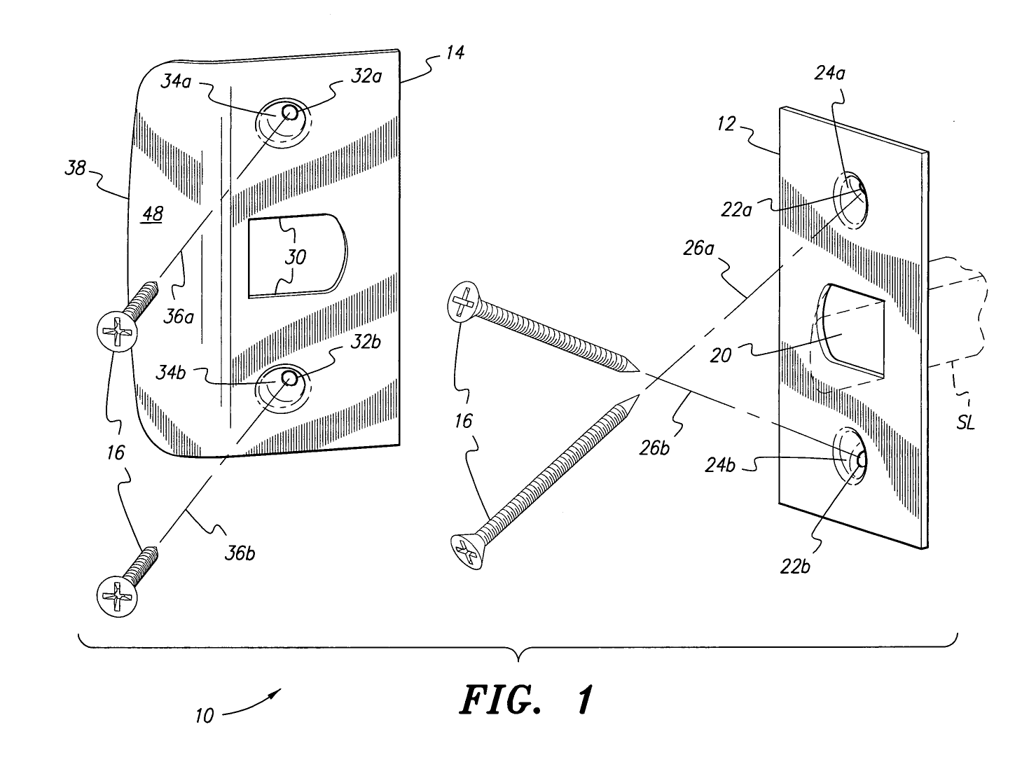

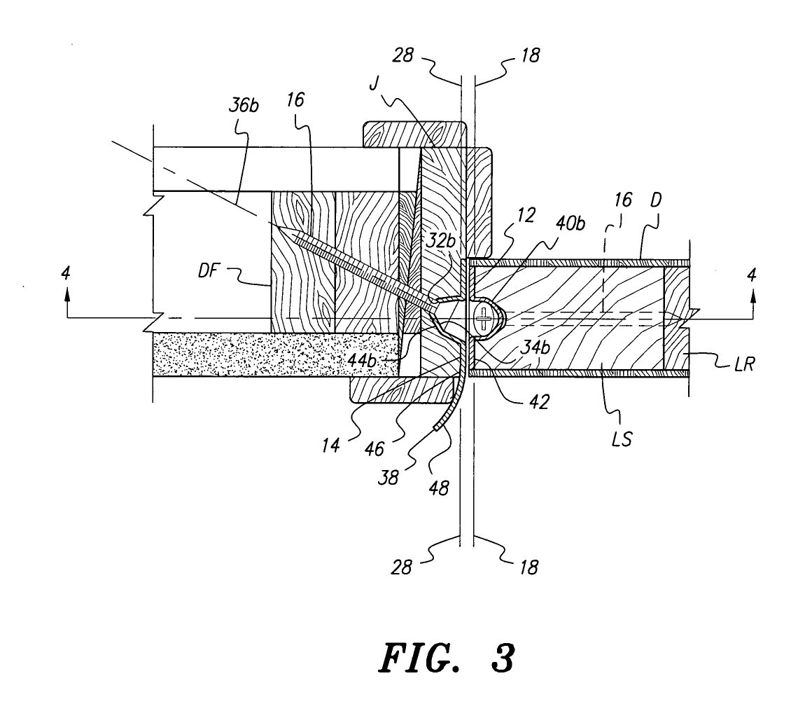

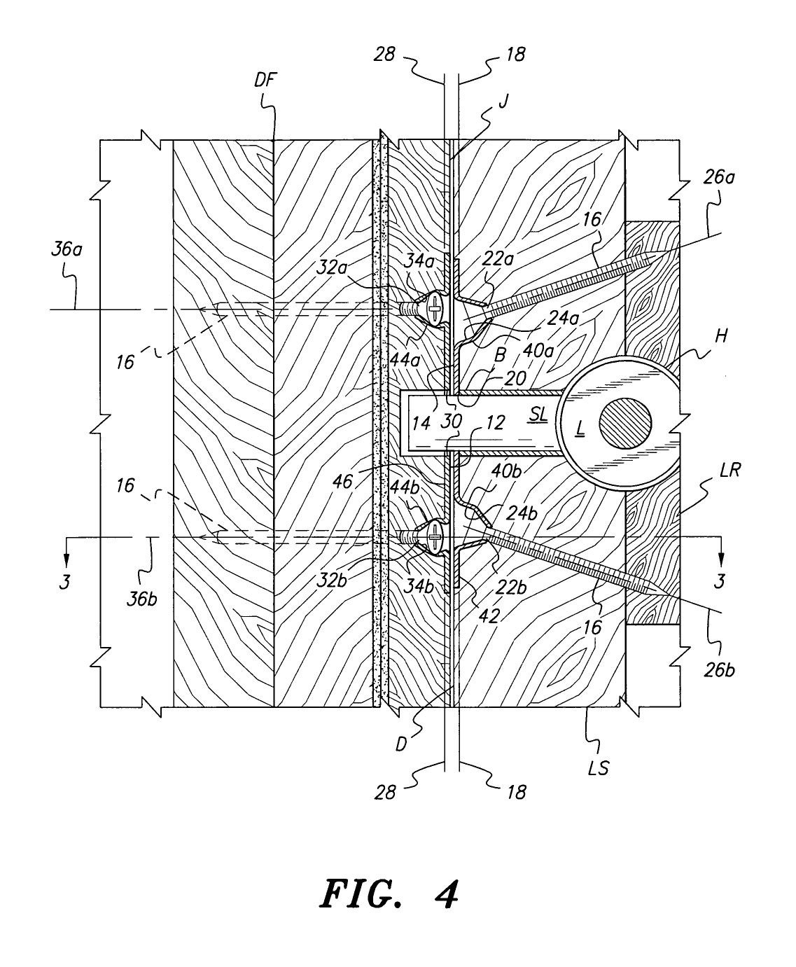

The door lock and jamb strike plates include various embodiments of door lock plates and jamb strike plates that be furnished in kits with accompanying hardware, or may be furnished as individual replacement parts, and provide for secure installation of all forms of door locks to resist break-ins. FIG. 1 of the drawings provides an exploded perspective view of all of the components that may be included in a kit 10 according to a first embodiment. The kit 10 includes a door lock or latch plate 12 for installation upon the edge of a door D (shown in FIGS. 3 and 4), a jamb strike plate 14 for installation along the door jamb J (shown in FIGS. 3 and 4), and a plurality of substantially identical, elongate door lock plate and jamb strike plate attachment screws 16.

The two plates 12 and 14 are similar to conventional plates, but provide for angles of the axes of their various attachment screw passages or holes, and have countersunk receptacles for the screw heads formed in the plates that are at oblique angles. In each case, the screw passages and screw head receptacles define acute angles with the planes of their respective plates, resulting in the screws being driven at non-orthogonal or oblique angles to the planes of the plates. This results in significant improvement in the attachment strength of the plates to their respective structures when screws of sufficient length are provided, and much greater resistance to damage by force.

The door lock plate 12 is best illustrated in FIGS. 1 and 4. The door lock plate 12 comprises a relatively thin (preferably about one to three millimeters thickness) flat metal sheet or plate defining a plane 18 (FIGS. 3 and 4). A lock or latch bolt passage 20 is formed generally centrally through the plate 12 for the retractile extension of a spring-biased sliding latch bolt SL therethrough. An upper screw passage 22a and screw head receptacle 24a are provided above the latch bolt passage 20, and a lower screw passage 22b and screw head receptacle 24b are formed through and in the plate 12 below the latch bolt passage 20. It will be noted that the screws 16 are flat head Philips screws having a frustoconical body, and the screw head receptacles 24a and 24b are each formed by a corresponding substantially frustoconical countersunk recess formed in the plate 12 about an oblique central axis 26a and 26b, respectively, which assists in guiding the screws 16 into the door D at oblique angles and requires that they be so driven in order to properly seat the heads of the screws 16. The same is true of the jamb plates 14, as described below.

It will be noted in FIG. 4, that the axes 26a and 26b of the two passages 22a, 22b and their receptacles 24a, 24b form acute angles with the plane 18 of the door lock plate 12, i.e., they are not orthogonal to the plane 18 of the plate 12. The upper axis 26a, and thus the shank of the upper screw 16, extends upwardly to pass above the borehole H and lockset or knob set L installed in the door D, and the lower axis 26b and shank of the lower screw 16 passes below the lockset L and its borehole H. The two axes 26a, 26b are not parallel to one another, but are coplanar and lie along the central plane of the door D, i.e., along the lines 4-4 in FIG. 3.

The door D illustrated in FIGS. 3 and 4 is a hollow core door having a vertical lock stile LS extending along the edge of the door D opposite the hinge edge and a horizontal lock rail LR extending between the lock stile LS and the opposite hinge stile (not shown). Conventionally, the screws attaching the door lock plate to the edge of the door are relatively short to avoid driving into the borehole of the door and contact with the lockset installed therein. The joint between the lock stile LS and the lock rail LR is a relatively weak point of the door structure, particularly when material is removed at this juncture when the lockset borehole H is cut. Accordingly, the driving of the upper and lower screws 16 at angles to miss the borehole H and its lockset L, completely through the lock stile LS and into the lock rail LR, greatly strengthens this area of the door D, thereby making it much more difficult to break the door in by means of force. The specific angle of the screws 16 may be any oblique angle, so long as the screws 16 do not interfere with the lock mechanism L installed in the door D, yet penetrate the horizontal lock rail LR of the door D. An angle of about thirty degrees relative to the horizontal is generally sufficient, but this will depend upon the setback of the lock mechanism L from the edge of the door D and the vertical width of the horizontal lock rail LR.

The jamb strike plate 14 is best illustrated in FIGS. 1 and 3. The jamb strike plate 14 is a relatively thin (preferably about one to three millimeters thickness, more or less) flat metal sheet or plate defining a plane 28 (FIGS. 3 and 4), as in the case of the door lock plate 12. A lock or latch bolt passage 30 is formed generally centrally through the jamb strike plate 14 for the extension of the spring-biased sliding latch bolt SL therein when the door D is closed and latched. An upper screw passage 32a and screw head receptacle 34a are provided above the latch bolt passage 30, with a lower screw passage 32b and screw head receptacle 34b being formed through and in the door lock plate 14 below the latch bolt passage 30.

As in the case of the door lock plate 12, the axes 36a and 36b of the two passages 32a, 32b and their receptacles 34a, 34b form acute angles with the plane 28 of the jamb strike plate 14, i.e., they are not orthogonal to the plane 28 of the plate 14. The two axes 36a, 36b, and thus the shanks of their screws 16, are parallel to one another and lie in different horizontal planes when the jamb strike plate 14 is installed in a vertical door jamb J. However, the screw passage and receptacle axes 36a and 36b are oriented away from the closure edge 38 of the jamb strike plate 14, and the screws 16 are installed through the screw passages 32a, 32b along their axes 36a, 36b extending away from the closure edge 38 of the jamb strike plate 14.

Jamb strike plates are conventionally installed near one edge of the door jamb J, i.e., adjacent to (and perhaps extending slightly beyond) the surface of the wall that is at least generally coplanar with the hinge side of the door. As a result, the screws securing the conventional jamb strike plate to the jamb are driven into the jamb quite close to its edge, thus allowing the screws and conventional jamb strike plate to be broken out of the jamb relatively easily. In contrast, the elongate screws 16 of the present jamb strike plate 14 are driven into and toward the center of the doubled door framing studs DF supporting the jamb J, thus providing considerably more material between the screws 16 and either wall side of the door framing studs DF and strengthening the installation accordingly.

It has been noted further above that the door lock or latch plate 12 and jamb strike plate 14 are formed of material preferably having a thickness on the order of one to three millimeters. The relatively thin nature of the plates 12 and 14 permit them to be manufactured by the known process of stamping, using appropriate dies. As a result, the sheet metal is deformed when forming the screw head receptacles 24a, 24b of the door lock plate 12 and receptacles 34a, 34b of the jamb strike plate 14. The result is a pair of protrusions 40a, 40b extending from the back surface 42 of the door lock or latch plate 12, with a similar pair of protrusions 44a, 44b extending from the back surface 46 of the jamb strike plate 14. Clearance for these protrusions 40a, 40b and 44a, 44b is easily made by drilling a shallow depression concentric with the axes of the screw passages 22a, 22b of the door lock or latch plate 12 and 32a, 32b of the jamb strike plate 14. The thin metal from which the various plates are made also reduces the amount of material that must be removed from the edge of the door and the jamb in a mortise cut, thereby facilitating the preparation of the door and jamb for installation of the plates.

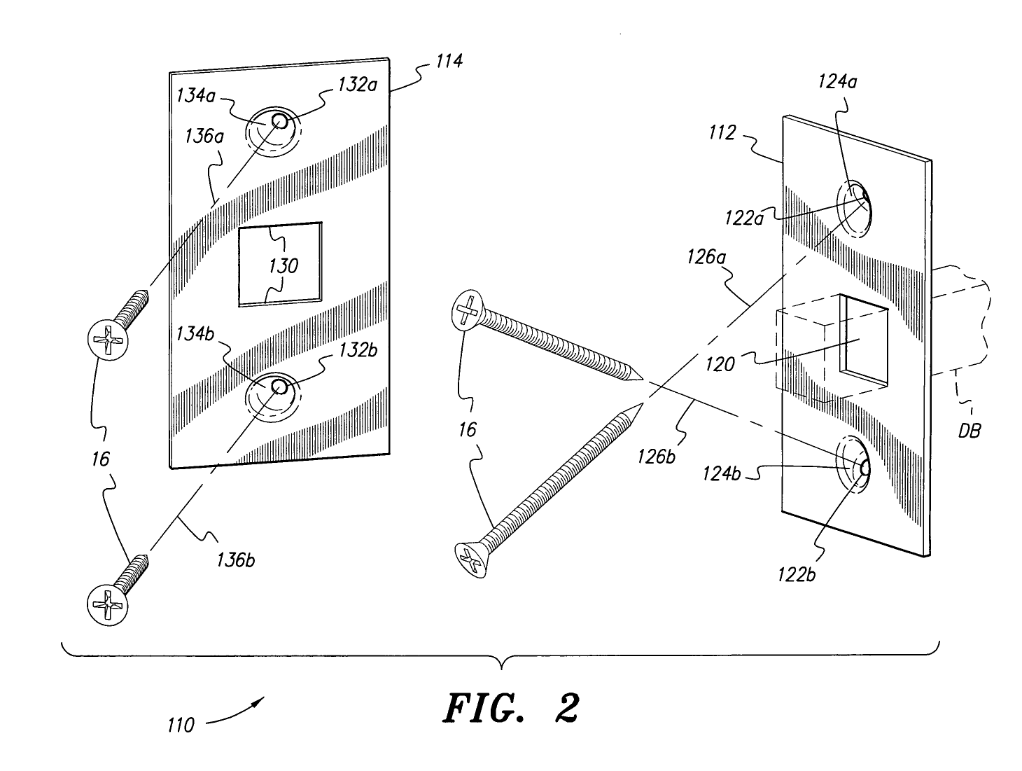

FIGS. 1, 3, and 4 illustrate the components of a kit 10 for installation with a door having a lockset with a spring biased sliding latch bolt SL having a tapered face. Accordingly, the jamb strike plate 12 includes a curved strike edge portion 48, against which the tapered face of the latch bolt SL slides when the door is closed. However, it will be seen that the door lock and jamb plates may also be configured for use with a deadbolt type lock system, as shown in FIG. 2 of the drawings.

The kit 110 of FIG. 2 includes a door lock or latch plate 112 configured for a deadbolt lock, i.e., a positively actuated deadbolt lock bolt DB that must be manually engaged with the corresponding jamb plate 114 after the door is closed. The deadbolt door lock or latch plate 112 is quite similar to the door lock or latch plate 12 of FIGS. 1, 3, and 4, having a central deadbolt passage 120 and screw passages 122a and 122b and their receptacles 124a and 124b, aligned with their axes 126a and 126b. However, the deadbolt passage 120 is shaped or configured to fit closely about the deadbolt DB, as opposed to the latch bolt passage 20 of the door latch plate 12.

The corresponding deadbolt jamb plate 114 is configured similarly to its counterpart plate 14 of FIGS. 1, 3, and 4, with the deadbolt jamb plate 114 having a central deadbolt passage 130 shaped to fit the deadbolt DB and screw passages 132a and 132b and their receptacles 134a and 134b, aligned with their axes 136a and 136b. However, the deadbolt jamb plate 114 does not include a curved strike edge portion, as the deadbolt DB cannot automatically retract upon contacting such a surface, as would be the case with the embodiment 10 of FIGS. 1, 3, and 4.

It will be seen that the door latch plate 12 and deadbolt lock plate 112 may be provided as separate components from the latch or deadbolt lockset, as desired. Alternatively, such a door latch or deadbolt lockset may include the appropriate plate 12 or 112, if so desired. Oftentimes such locksets include the door face plate therewith, with the door face plate being permanently secured or removably secured (to facilitate installation of the lockset in the door) to the end of the bolt barrel B (FIG. 4) in which the sliding latch bolt SL or deadbolt resides. Accordingly, either of the door plates 12 or 112 may be provided in combination with a corresponding lockset, or such a lockset may be provided in combination with the other components of either of the kits 10 or 110, as desired. Any of the above kits and their installations will serve to increase the strength of a door latch or lock installation significantly, over such latch and lock assemblies developed in the past.

It is to be understood that the present invention is not limited to the embodiments described above, but encompasses any and all embodiments within the scope of the following claims.

1. A door lock installation kit, comprising:
a vertically elongated door lock plate defining a plane and a vertical axis, the door lock plate having a back surface, top and bottom edges, and first and second side edges, the plate adapted to be installed vertically on a door frame with the back surface engaging the door frame, a latch passage disposed generally centrally therethrough, the door lock plate consisting of an upper screw passage and screw head receptacle disposed centrally therein and aligned with the vertical axis, a lower screw passage and screw head receptacle disposed centrally therein and aligned with the vertical axis, each screw passage and screw head receptacle having an axis defining an oblique angle with the plane of the door lock plate, the axis of the upper screw passage and screw head receptacle being oriented upwardly and the axis of the lower screw passage and screw head receptacle being oriented downwardly when the plane of the door lock plate is installed vertically, wherein the axes of the screw passages are vertically aligned in the same plane;
a jamb strike plate defining a plane, the jamb strike plate having a back surface, a closure edge, a latch passage disposed generally centrally therethrough, an upper screw passage and screw head receptacle disposed centrally therein and aligned with a vertical axis of the latch passage, and a lower screw passage and screw head receptacle disposed centrally therein and aligned with the vertical axis of the latch passage, each screw passage and screw head receptacle having an axis defining an oblique angle with the plane of the jamb strike plate, wherein the axes of the screw passages are vertically aligned in the same plane, the axis of each screw passage and screw head receptacle extending away from the closure edge of the jamb strike plate and reside within a horizontal plane, wherein the horizontal planes are parallel;
elongate first and second door lock plate attachment screws; and
elongate first and second jamb strike plate attachment screws.

2. The door lock plate installation kit according to claim 1, wherein:
each screw head receptacle defines a protrusion extending from the back surface of the door lock plate; and
each screw head receptacle defines a protrusion extending from the back surface of the jamb strike plate.

3. The door lock installation kit according to claim 1, wherein the jamb strike plate has a curved strike edge portion.

4. The door lock installation kit according to claim 1, further including a door lock set.

5. The door lock plate and jamb strike plate installation kit according to claim 1, wherein the door lock plate and the jamb strike plate each have a thickness between one and three millimeters.

6. A method of manufacturing the door lock installation kit of claim 1, comprising the steps of:
(a) forming the door lock plate by stamping; and
(b) forming the jamb strike plate by stamping.

7. A door lock apparatus, comprising:
a vertically elongated door lock plate, the door lock plate defining a plane and a vertical axis, the door lock plate having a back surface, top and bottom edges, and first and second side edges, the plate adapted to be installed vertically on a door frame with the back surface engaging the door frame, a latch passage disposed generally centrally therethrough, the door lock plate consisting of an upper screw passage and screw head receptacle disposed centrally therein and aligned with the vertical axis, a lower screw passage and screw head receptacle disposed centrally therein and aligned with the vertical axis, each screw passage and screw head receptacle having an axis defining an oblique angle with the plane of the door lock plate, the axis of the upper screw passage and screw head receptacle being oriented upwardly and the axis of the lower screw passage and screw head receptacle being oriented downwardly when the plane of the door lock plate is installed vertically, wherein the axes of the screw passages are vertically aligned in the same plane, each screw head receptacle defining a protrusion extending from the back surface of the door plate.

8-18. (canceled)
